(19) United States
(12) Patent Application Publication
(10) Pub. No.: US 2025/0097971 A1
(43) Pub. Date: Mar. 20, 2025

(54) METHODS, DEVICES, AND SYSTEMS FOR SCHEDULING GAP COORDINATION

(71) Applicant: ZTE Corporation, Shenzhen (CN)

(72) Inventors: Wenting LI, Shenzhen (CN); Jing LIU, Shenzhen (CN); He HUANG, Shenzhen (CN)

(73) Assignee: ZTE Corporation, Shenzhen (CN)

(21) Appl. No.: 18/966,356

(22) Filed: Dec. 3, 2024

Related U.S. Application Data
(63) Continuation of application No. PCT/CN2022/122949, filed on Sep. 29, 2022.

(51) Int. Cl. H04W 72/563; H04W 72/0453

(52) U.S. Cl. CPC H04W 72/563; H04W 72/0453

(57) ABSTRACT

The present disclosure describes methods, systems, and devices for scheduling gap coordination. One method includes determining, by a user equipment (UE), a scheduling gap (SG) granularity in a network; and transmitting, by the UE, a message comprising the determined SG granularity to the network. Another method includes receiving, by a network, assistance information from a UE; configuring, by the network based on the assistance information, a SG granularity; transmitting, by the network, reconfiguration information to the UE, the reconfiguration information comprising the determined SG granularity; and receiving, by the network, reconfiguration complete information from the UE.

### TECHNICAL FIELD

The present disclosure is directed generally to wireless communications. Particularly, the present disclosure relates to methods, devices, and systems for scheduling gap coordination.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

For the new generation mobile communication technology, a user equipment (UE), for example, a smart phone, may camp on more than one networks (for example, network A and network B). The UE may need scheduling gap with the network A to execute some signaling transmission and reception (Tx/Rx) on the network B. There may be some problems/issues associated with scheduling gap coordination.

The present disclosure may address at least one of issues/problems associated with the existing system and describes various embodiments for scheduling gap coordination, improving the performance of the wireless communication.

### SUMMARY

This document relates to methods, systems, and devices for wireless communication, and more specifically, for scheduling gap coordination.

In one embodiment, the present disclosure describes a method for wireless communication. The method includes determining, by a user equipment (UE), a scheduling gap (SG) granularity in a network; and transmitting, by the UE, a message comprising the determined SG granularity to the network.

In another embodiment, the present disclosure describes a method for wireless communication. The method includes receiving, by a network, assistance information from a user equipment (UE); configuring, by the network based on the assistance information, a scheduling gap (SG) granularity; transmitting, by the network, reconfiguration information to the UE, the reconfiguration information comprising the determined SG granularity; and receiving, by the network, reconfiguration complete information from the UE.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods. The computer-readable medium may be referred as non-transitory computer-readable media (CRM) that stores data for extended periods such as a flash drive or compact disk (CD), or for short periods in the presence of power such as a memory device or random access memory (RAM).

The above and other aspects and their implementations are described in greater detail in the drawings, the descriptions, and the claims.

### BRIEF DESCRIPTION OF THE DRAWINGS

FIG. 1A shows an example of a wireless communication system include more than one network nodes and one or more user equipment.

FIG. 1B shows a schematic diagram of an exemplary embodiment for wireless communication.

FIG. 2 shows an example of a network node.

FIG. 3 shows an example of a user equipment.

FIG. 4 shows a flow diagram of a method for wireless communication.

FIG. 5 shows a flow diagram of a method for wireless communication.

FIG. 6 shows a schematic diagram of an exemplary embodiment for wireless communication.

FIG. 7 shows a schematic diagram of another exemplary embodiment for wireless communication.

FIG. 8 shows a schematic diagram of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for scheduling gap coordination.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfill the requirements from different industries and users.

For the new generation mobile communication technology, a user equipment (UE), for example, a smart phone, may camp on more than one networks (for example, network A and network B). The UE may need scheduling gap with the network A, e.g. to execute some signaling transmission and reception (Tx/Rx) on the network B. There may be some problems/issues associated with scheduling gap coordination. The present disclosure may address at least one of issues/problems associated with the existing system and describes various embodiments for scheduling gap coordination, improving the performance of the wireless communication.

Under one or more scenarios, a user equipment (UE) may connect to more than one networks at the same time. In this disclosure, as non-limiting examples, various embodiments for scheduling gap coordination are described when the UE is working at multi-radio dual connectivity (MR-DC) structure. In other situations, when the UE may work at any dual connectivity structure, for example, multiple subscriber identity modules (Multi-SIMs) (or multiple universal subscriber identity modules (Multi-USIMs)), various embodiments in the present disclosure may be applicable as well.

In some implementations, in the MR-DC structure, a UE may be simultaneously connected to two different radio access network nodes, for example, one network node provides new radio (NR) access and the other network node provides 4G (or LTE) access.

In some implementations, in the MR-DC structure, one of network nodes serving the UE acts as a master node (MN), which provides primary radio resources via a master cell group (MCG); and another of the network nodes serving the UE acts as a secondary node (SN), which provides additional radio resources to the UE via a secondary cell group (SCG).

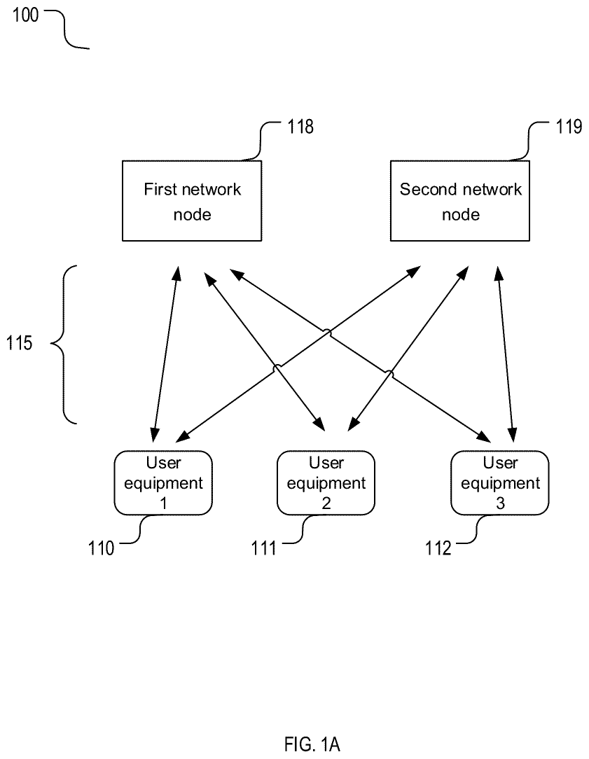

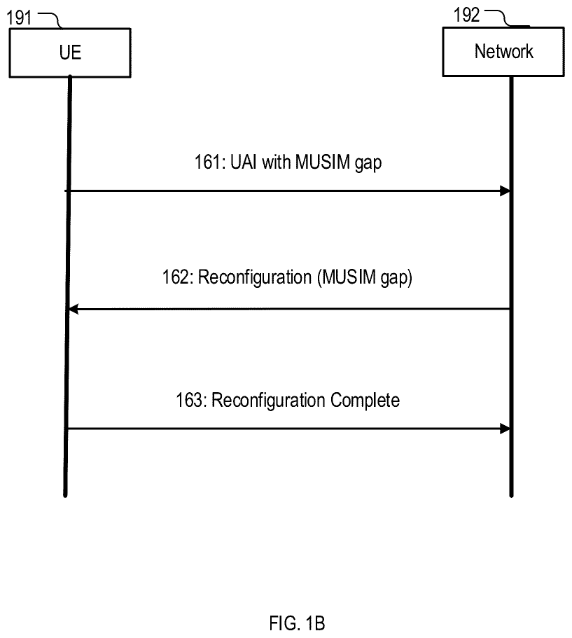

FIG. 1A shows a wireless communication system 100 including more than one wireless network nodes (118 and 119) and one or more user equipment (UE) (110, 111, and 112).

The wireless network node (118 and 119) may include a network base station, which may be a nodeB (NB, e.g., eNB, or gNB) in a mobile telecommunications context. Each of the UE (110, 111, and/or 112) may wirelessly communicate with the wireless network node (118 and/or 119) via one or more radio channels 115. For example, the first UE 110 may wirelessly communicate with the first network node 118 via a channel including a plurality of radio channels during a certain period of time; during another period of time or simultaneously at the same time, the first UE 110 may wirelessly communicate with the second network node 119 via a channel including a plurality of radio channels.

In some implementations, an idle (or inactive) state signaling may be received by the periodic or aperiodic gap. For example, in a MUSIM scheduling gap request and configure procedure in FIG. 1B, a UE (191) would send the MUSIM scheduling gap in the UE assistance information to a network node (192) as below: in step 161, the UE sends a UE assistance information (UAI) with MUSIM gap to the network; in step 162, the network sends a reconfiguration message including MUSIM gap to the UE; and/or in step 163, the UE sends a reconfiguration complete message to the network. In some implementations, the UE (191) may include a first subscriber identity module (SIM1) access stratum (AS); and/or the network node (192) may include a SIM1 gNB A. In the above example, the scheduling gap granularity is per UE, and the coordination between the MCG and SCG is not described.

The present disclosure describes various embodiments for scheduling gap coordination. For example, some embodiments may describe how to receive idle/inactive state signalling at another network (e.g., network B) when the UE is working in MR-DC structure with one network (e.g., network A).

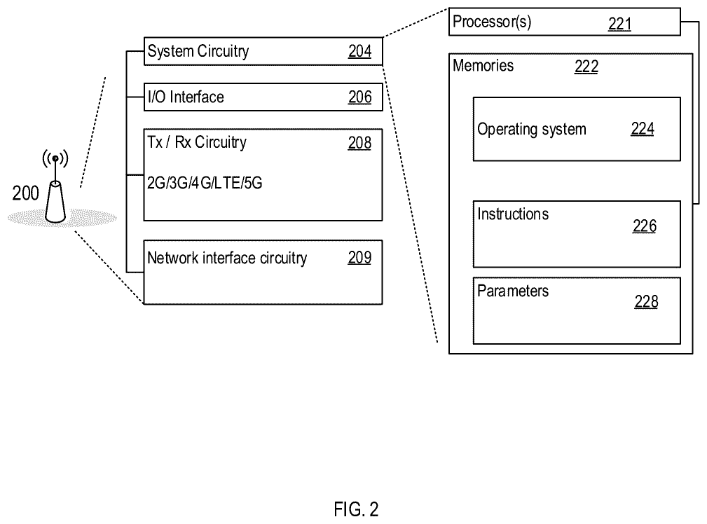

FIG. 2 shows an example of electronic device 200 to implement a network node or network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

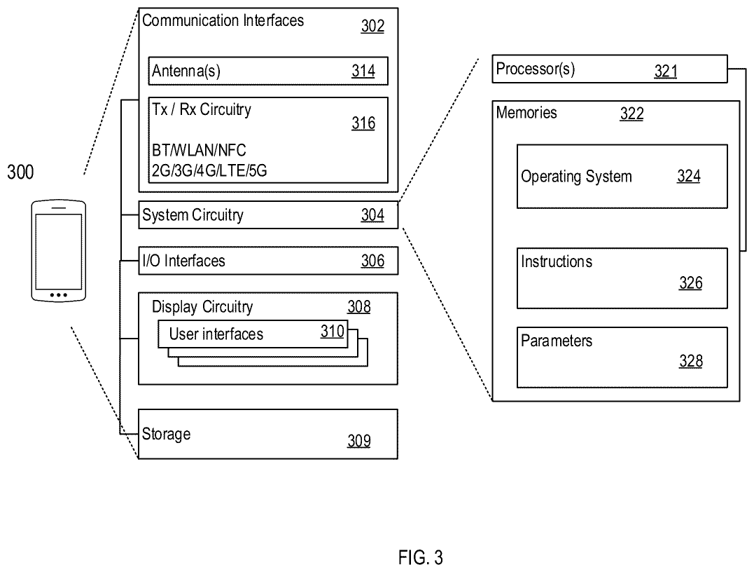

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310.

The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G, and/or further developed standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes several below embodiments, which may be implemented, partly or totally, on the network base station and/or the user equipment described above in FIGS. 2-3.

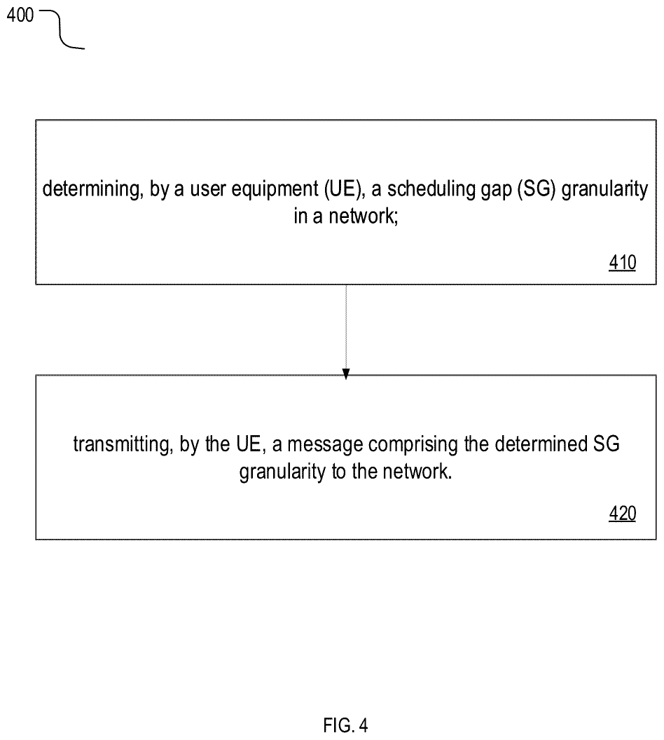

Referring to FIG. 4, the present disclosure describes embodiments of a method 400 for wireless communication. The method 400 may include a portion or all of the following: step 410, determining, by a user equipment (UE), a scheduling gap (SG) granularity in a network, the SG can be used by the UE to communicate with another network; and/or step 420, transmitting, by the UE, a message comprising the determined SG granularity to the network.

In some implementations, in additional to a portion or a combination of implementations or embodiments described in the present disclosure, the method 400 may further include a portion or all of the following: receiving, by the UE, reconfiguration information from the network; and/or transmitting, by the UE, reconfiguration complete information to the network.

In some implementations, in additional to a portion or a combination of implementations or embodiments described in the present disclosure, the message comprises a UE assistance information (UAI) message with SG request.

In some implementations, in additional to a portion or a combination of implementations or embodiments described in the present disclosure, in response to the determined SG granularity being per UE gap, the message indicates per UE granularity information; or in response to the determined SG granularity being per frequency range (FR) gap, the message indicates one of a first FR (FR1) or a second FR (FR2); or in response to the determined SG granularity being per cell group (CG) gap, the message indicates one of a master cell group (MCG) or a secondary cell group (SCG); or in response to the determined SG granularity being per component carrier (CC) gap, the message indicates at least one CC index.

In some implementations, in additional to a portion or a combination of implementations or embodiments described in the present disclosure, the message comprises a SG list; and/or the message comprises one of the following: a SG granularity for the SG list, or a SG granularity for each SG in the SG list.

In some implementations, in additional to a portion or a combination of implementations or embodiments described in the present disclosure, the network changes the determined SG granularity from the UE to obtain a modified SG granularity; and/or reconfiguration information from the network comprises the modified SG granularity.

In some implementations, in additional to a portion or a combination of implementations or embodiments described in the present disclosure, in response to the determined SG granularity being reserved for a SCG, the UE transmits the message directly to the secondary node via a signal radio bearer (SRB).

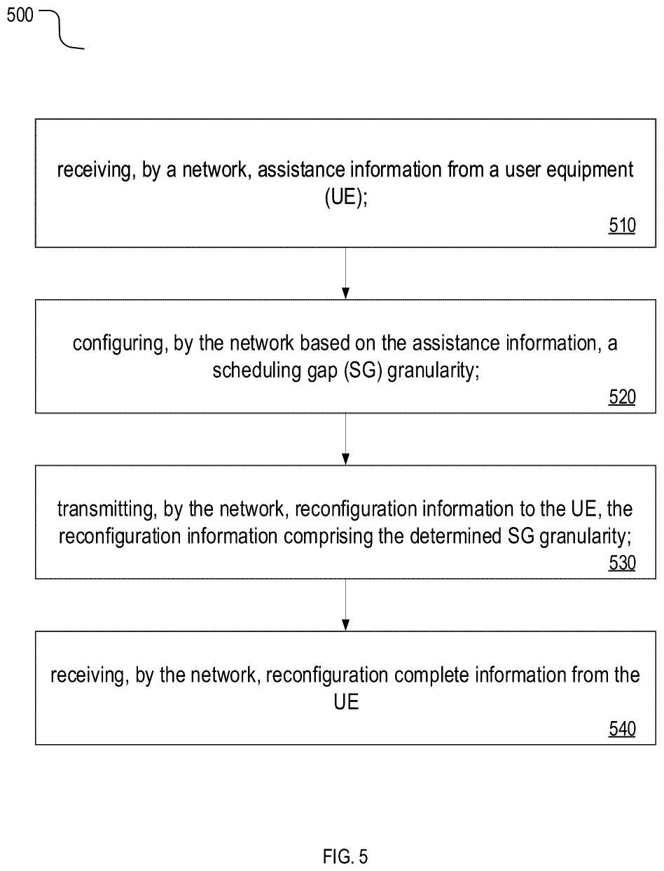

Referring to FIG. 5, the present disclosure describes embodiments of a method 500 for wireless communication. The method 500 may include a portion or all of the following: step 510, receiving, by a network, assistance information from a user equipment (UE); step 520, configuring, by the network based on the assistance information, a scheduling gap (SG) granularity, this scheduling gap can be used by the UE to communicate with another network; step 530, transmitting, by the network, reconfiguration information to the UE, the reconfiguration information comprising the determined SG granularity; and/or step 540, receiving, by the network, reconfiguration complete information from the UE.

Without limitation to the present disclosure, the various embodiments described below may use a UE working in a MR-DC structure with a network (e.g., network A). These embodiments are examples and do not limit the present disclosure, and the present disclosure may also be applied to the other scenarios that a UE connect to the two networks simultaneously.

In some implementations, in additional to a portion or a combination of implementations or embodiments described in the present disclosure, the assistance information comprises at least one of the following: band information, an affected center frequency, an affected bandwidth, FR information, PDSCH configuration information, a MIMO layer, a modulation order, allowed band combination information, affected band combination information, featureset combination information, or featureset entry information.

In some implementations, in additional to a portion or a combination of implementations or embodiments described in the present disclosure, the network comprises a master node and a secondary node; the master node sends a first message to the secondary node, the first message comprising SG information with the determined SG granularity; in response to determining that the SG information is acceptable, the secondary node sends a second message to the master node, the second message indicating an acceptance of the SG information with the determined SG granularity implicitly or explicitly; and/or the master node sends the reconfiguration information to the UE.

In some implementations, in additional to a portion or a combination of implementations or embodiments described in the present disclosure, the first message comprises CG configuration information; and/or the second message comprises CG configuration.

In some implementations, in additional to a portion or a combination of implementations or embodiments described in the present disclosure, in response to the determined SG granularity being per UE gap: the master node determines SG information and sends a first message comprising the SG information with the SG granularity to the secondary node, the secondary node sends a second message indicating an acceptance of the SG information to the master node implicitly or explicitly, and the master node configures the SG information with the SG granularity to the UE.

In some implementations, in additional to a portion or a combination of implementations or embodiments described in the present disclosure, in response to the determined SG granularity being per FR gap and a SCG comprising a serving cell on a corresponding FR: the master node sends a first message comprising SG information with the SG granularity to the secondary node, the secondary node sends a second message indicating an acceptance of the SG information to the master node implicitly or explicitly, and the master node configures the SG information with the SG granularity to the UE.

In some implementations, in additional to a portion or a combination of implementations or embodiments described in the present disclosure, in response to the determined SG granularity being per CG gap for an MCG gap: the master node configures the SG information with the SG granularity to the UE.

In some implementations, in additional to a portion or a combination of implementations or embodiments described in the present disclosure, in response to the determined SG granularity being per CG gap for an SCG gap: the master node sends a first message comprising assistance information, SG information with the SG granularity to the secondary node, the secondary node determines the SG information, SG granularity, and/or sends a second message indicating an acceptance of the SG information to the master node, and/or the master node configures the SG information with the SG granularity to the UE.

In some implementations, in additional to a portion or a combination of implementations or embodiments described in the present disclosure, in response to the determined SG granularity being per CC gap and a SCG comprising a serving cell on a corresponding CC: the master node sends a first message comprising assistance information, SG information with the SG granularity, and one or more related CC index to the secondary node, the secondary node determines the SG information, SG granularity, and/or sends a second message indicating an acceptance of the SG information to the master node, and the master node configures the SG information with the SG granularity to the UE.

In some implementations, in additional to a portion or a combination of implementations or embodiments described in the present disclosure, in response to the determined SG granularity being per CG gap for an SCG gap: the master node sends a first message comprising at least one of assistance information, or SG information with the SG granularity to the secondary node, the secondary node determines the SG information, SG granularity, and/or the secondary node transmits the SG information with the SG granularity to the UE directly via an SRB.

In some implementations, in additional to a portion or a combination of implementations or embodiments described in the present disclosure, in response to the determined SG granularity being per CC gap and a SCG comprising a serving cell on a corresponding CC: the master node sends a first message comprising at least one of assistance information, SG information with the SG granularity, or one or more related CC index to the secondary node, the secondary node determines the SG information, SG granularity, and/or the secondary node transmits the SG information with the SG granularity to the UE directly via an SRB.

In some implementations, in additional to a portion or a combination of implementations or embodiments described in the present disclosure, in response to the determined SG granularity being per CG gap for an SCG gap: the master node sends a first message comprising at least one of assistance information, SG information with the SG granularity to the secondary node, the secondary node determines the SG information, SG granularity, and/or sends a second message indicating an acceptance of the SG information to the master node, and the secondary node transmits the SG information with the SG granularity to the UE directly via an SRB.

In some implementations, in additional to a portion or a combination of implementations or embodiments described in the present disclosure, in response to the determined SG granularity being per CC gap and a SCG comprising a serving cell on a corresponding CC: the master node sends a first message comprising at least one of assistance information, SG information with the SG granularity, one or more related CC index to the secondary node, the secondary node determines the SG information and/or sends a second message indicating an acceptance of the SG information to the master node, and the secondary node transmits the SG information with the SG granularity to the UE directly via an SRB.

In some implementations, in additional to a portion or a combination of implementations or embodiments described in the present disclosure, the UE transmits UE capability information to the network, the UE capability information indicating one or more SG granularity that are supported by the UE, the one or more SG granularity comprising one or more of the following: per UE SG, per FR SG, per CG SG, and per CC SG.

In some implementations, in additional to a portion or a combination of implementations or embodiments described in the present disclosure, the network indicates the UE to report SG granularity with at least one dedicated SG type, so that the UE is limited to determine the SG granularity with a SG type in the at least one dedicated SG type; or the network indicates the UE to report SG granularity without any dedicated SG type, so that the UE determines the SG granularity with any SG type.

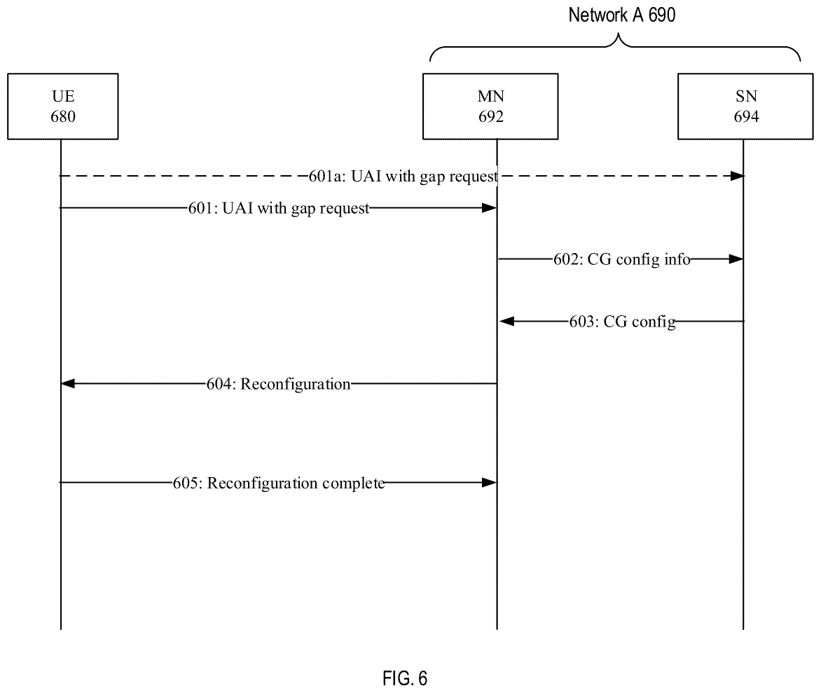

The present disclosure describes various exemplary embodiments for scheduling gap coordination, which serve as examples and do not impose any limitation on the present disclosure. For non-limiting examples, a UE is working at MR-DC with network A, and, referring to FIG. 6, a general procedure for the MR-DC scheduling gap coordination may include a portion or all of the following: step 601, a UE (680) sends a UAI with gap request to a MN (692) in a network A (690); step 602, the MN sends cell group (CG) configuration information to a SN 694 in the network A; step 603, the SN sends a CG configuration to the MN; step 604, the MN sends a reconfiguration message to the UE; and/or step 605, the UE sends a reconfiguration complete message to the MN. Specifically, the non-limiting examples addresses various problems/issues, including which node determines the scheduling gap granularity (e.g. per UE gap, per FR gap, per CG gap, per CC gap), the UE or the network, what the interaction between the MN and SN is for each scheduling gap granularity and what the network configuration of the scheduling gap for each granularity is; and/or how the UE indicates the related capability.

### Embodiments on Determining the Scheduling Gap Granularity

Various embodiments in the present disclosure describe which node determines the scheduling gap granularity (e.g. per UE gap, per FR gap, per CG gap, per CC gap), the UE or the network.

In one embodiment, the UE may determine the scheduling gap granularity and indicate it to the network.

When the scheduling gap granularity is the per UE gap, the UE may indicate the per UE granularity. In some implementations, for the MR-DC, this gap is reserved for both the MCG and SCG, and also for both FR1 and FR2.

When the scheduling gap granularity is the per FR gap, the UE need to indicate the FR range, i.e. FR1 or FR2. In some implementations, for the MR-DC, this gap is reserved for either FR1 or FR2, which means the gap was reserved only on the serving cell on the corresponding FR.

When the scheduling gap granularity is the per CG gap, the UE may indicate the specific CG, i.e. SCG or MCG. In some implementations, for the MR-DC, this gap is reserved for either MCG or SCG, which means the gap was reserved only on the serving cell on the corresponding CG.

When the scheduling gap granularity is the per CC gap, the UE may indicate the CC index.

In some implementations, as an example of a combination of more than two types of above gap granularity, the UE may indicate the scheduling gap granularity being per CG per FR gap.

In some implementations, the UE may indicate the granularity to the network in assistance information.

In some implementations, for the SCG case (the gap is only reserved at SCG), the UE may directly send the UAI to the SN via a SRB3, for example, in step 601a in FIG. 6: the UE sends UAI with gap request directly to the SN via a SRB3.

For one example, the UE may indicate the scheduling gap type in the UAI as below:

```
  SchedulingGapAssistanceInfo := SEQUENCE
  {
```

| | |
|---|---|
| schedulinggapPref | SchedulingGapPreferenceList |

schedulinggapGranylarity ENUMERATED {perUE, perFR1, per FR2, MCG, SCG, per CC}
OPTIONAL,

| | |
|---|---|
| ccIndex | CCIndex OPTIONAL |

```
  }
  SchedulingGapPreferenceList ::= SEQUENCE (SIZE (1..3)) OF SchedulingGapPrefInfo
  SchedulingGapPrefInfo ::= SEQUENCE {
  SchedulingStarting-SFN-AndSubframe SchedulingStarting-SFN-AndSubframe OPTIONAL,
  SchedulingGapLength ENUMERATED {ms3, ms4, ms6, ms10, ms20},
  SchedulingGapRepetitionAndOffset CHOICE {
  ms20 INTEGER (0..19),
  ms40 INTEGER (0..39), ... } OPTIONAL }
```

For another example, the UE may indicate the gap granularity for each gap, e.g. UE indicates the scheduling gap granularity for each gap in the UAI as below:

```
  SchedulingGapAssistanceInfo := SEQUENCE
  {
```

| | |
|---|---|
| schedulinggapPref | SchedulingGapPreferenceList |

```
  }
  SchedulingGapPreferenceList ::= SEQUENCE (SIZE (1..3)) OF SchedulingGapPrefInfo
  SchedulingGapPrefInfo ::= SEQUENCE {
  SchedulingStarting-SFN-AndSubframe SchedulingStarting-SFN-AndSubframe OPTIONAL,
  SchedulingGapLength ENUMERATED {ms3, ms4, ms6, ms10, ms20},
  SchedulingGapRepetitionAndOffset CHOICE {
  ms20 INTEGER (0..19),
  ms40 INTEGER (0..39),
    ... } OPTIONAL }
    schedulinggapGranylarity ENUMERATED {perUE, perFR1, per FR2, MCG, SCG, per CC}
OPTIONAL,
```

| | |
|---|---|
| ccIndex | CCIndex OPTIONAL |

}

In another embodiment, the network may determine the scheduling gap granularity (e.g. per UE gap, per FR gap, per CG gap, per CC gap). In some implementations, the network determine the scheduling gap granularity based on the UE assistance information. The assistance information may include at least one of the following categories of information.

One category of information may be frequency domain related information, including at least one of the following: band information, affected centry frequency and bandwidth, frequency range information (e.g., FR1 or FR2).

Another category of information may indicate the physical downlink shared channel (PDSCH) configuration information on the related band, e.g. multiple input multiple output (MIMO) layer, and/or modulation order.

Another category of information may include at least one of allowed/affected band combination information, featureset combination information, featureset entry information and so on. By this method, the network may determine which BC with which featuresetentry may be adopted, and further determine which kind of gap may be adopted.

In some implementations, for the case that the UE determines the granularity in previous embodiment, the network may also change the granularity, e.g. change the per CG or per FR gap to the per UE gap, or change the per CC gap to the per CG or per UE gap.

In some implementations, the UE indicates the assistance Information for the scheduling gap granularity determination as follow:

SchedulingGapAssistanceInfo :=
{

| | | |
|---|---|---|
| BandInfo | EARFCN or ARFCN | Optional |
| AffectedBandwidth | bandwidth | Optional |

| | |
|---|---|
| schedulinggapPref | SchedulingGapPreferenceList |

}
SchedulingGapPreferenceList ::= SEQUENCE (SIZE (1..3)) OF SchedulingGapPrefInfo
SchedulingGapPrefInfo ::= SEQUENCE {
SchedulingStarting-SFN-AndSubframe SchedulingStarting-SFN-AndSubframe OPTIONAL,
SchedulingGapLength ENUMERATED {ms3, ms4, ms6, ms10, ms20},
SchedulingGapRepetitionAndOffset CHOICE {
ms20 INTEGER (0..19),
ms40 INTEGER (0..39), ... } OPTIONAL }

As a combination scheme, the UE may also indicate the SG granularity info together with the scheduling gap assistance information; and/or the network may either accept the UE's indicated SG granularity or determine the SG based on the scheduling gap assistance information.

### Embodiments on Interaction Between MN and SN

Various embodiment describes the interactions between a MN and a SN in a network for each scheduling gap granularity and the network configuration.

When the gap granularity is indicated by the UE or determined by network, the MN indicates the gap info and/or the gap granularity to the SN; the SN may accept or reject this gap reservation. The network may configure the scheduling gap information and/or the gap granularity to the UE.

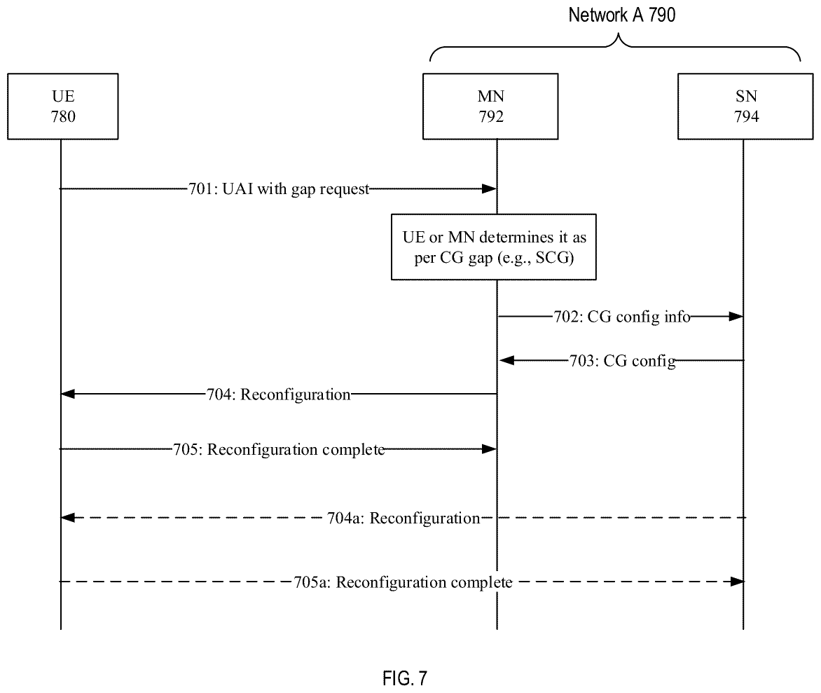

FIG. 7 shows interactions between the MN and the SN: step 701, a UE (780) sends a UAI with gap request to a MN (792) in a network A (790); step 702, the MN sends CG configuration information to a SN 794 in the network A; step 703, the SN sends a CG configuration to the MN; step 704, the MN sends a reconfiguration message to the UE; and/or step 705, the UE sends a reconfiguration complete message to the MN. Alternatively, when the UE or the MN determines it as per CG group (e.g., SCG), in step 704a, the SN sends a reconfiguration message to the UE; and/or step 705a, the UE sends a reconfiguration complete message to the SN.

In some implementations, when the scheduling gap granularity is determined as a per UE gap, the MN determines the gap information, and/or indicates the gap information and/or the gap granularity (per UE) to the SN. The network configures the scheduling gap information and/or the gap granularity to the UE.

In some implementations, when the scheduling gap granularity is determined as a per FR gap, and when the SCG includes the serving cell on the corresponding FR, the MN indicates the gap information and/or the gap granularity to the SN. The network configures the scheduling gap information and/or the gap granularity to the UE.

In some implementations, when the scheduling gap granularity is determined as a per CG gap, and when it's a MCG gap, no coordination needed; when it's a SCG gap, the MN indicates the gap information and/or the gap granularity to the SN. Then the SN determines the scheduling gap information, and/or the SCG scheduling gap may be sent to MN and let the MN send it to the UE. Alternatively and optionally, the SN may sends the scheduling gap information to the UE through a SRB3 directly.

In some implementations, when the scheduling gap granularity is determined as a per CC gap, and when the SCG includes the serving cell on the corresponding CC, the MN indicates the gap information and/or the Gap granularity and/or the related CC index to the SN. Then the SN determines the scheduling gap information, and/or the SCG scheduling gap may be sent to the MN and let the MN send it to the UE. Alternatively and optionally, the SN may send the scheduling gap information to the UE through a SRB3 directly.

In some implementations, in this scheduling gap, the network may suspend both the uplink (UL) and downlink (DL) transmission as the measurement gap has done. Alternatively and optionally, as an enhancement, only DL may be affected, and/or the UE may send the UL signalling, e.g., scheduling Gap with reduced capability.

In some implementations, for coordination between the MN and the SN for the per UE or per FR gap, the MN may send the schedulingGapConfigure to the SN within the inter-node message as below:

schedulingGapConfigure := SEQUENCE
{

| | | |
|---|---|---|
| schedulingGapConfig | SetupRelease { SchedulingGapConfigList } | OPTIONAL, |
| gapGranularity | ENUMERATED {perUE, perFR1, per FR2} | OPTIONAL, |

}
SchedulingGapConfigList ::= SEQUENCE (SIZE (1..3)) OF SchedulingGapConfig
SchedulingGapConfigList ::= SEQUENCE {
SchedulingStarting-SFN-AndSubframe SchedulingStarting-SFN-AndSubframe OPTIONAL,
SchedulingGapLength ENUMERATED {ms3, ms4, ms6, ms10, ms20},
SchedulingGapRepetitionAndOffset CHOICE {
ms20 INTEGER (0..19),
ms40 INTEGER (0..39), ... } OPTIONAL }

In some implementations, the MN sends the configuration to the UE in the reconfiguration message.

In some implementations, when it is determined as a SCG gap, the MN may send the scheduling gap assistance information to the SN, the SN determines the scheduling gap information, and/or the SCG scheduling gap may be sent to the MN and let the MN send it to the UE. Alternatively and optionally, the SN sends the scheduling gap info to the UE through a SRB3 directly.

In some implementations, for coordination between the MN and SN for the SCG gap, the MN may send the schedulingGapConfigure to the SN within the inter-node message as below:

| schedulingGapAssistanceInfo := Sequence | | |
|---|---|---|
| { | | |
| schedulingGapAssistance | SchedulingGapAssistanceInfo | OPTIONAL, |
| gapGranularity | ENUMERATED {MCG, SCG} | OPTIONAL, |

}

In some implementations, the SN may determine the schedulingGapConfigure to the MN or to the UE via a SRB3 immediately as below:

schedulingGapConfigure := Sequence
{

| | | |
|---|---|---|
| schedulingGapConfig | SetupRelease { SchedulingGapConfigList } | OPTIONAL, |
| gapGranularity | ENUMERATED {MCG, SCG} | OPTIONAL, |

}

In some implementations, when the SN sends the schedulingGapConfigure to the MN, the MN may send the schedulingGapConfigure to the UE in the reconfiguration message.

In some implementations, for coordination between the MN and SN for the per CC gap, when it is determined as a per CC gap, and when the SCG include the serving cell on the corresponding CC, the MN indicates the gap information and/or the gap granularity and/or the related CC index to the SN. For example, the

MN may send the schedulingGapConfigure to the SN within the inter-node message as below:

```
  schedulingGapAssistanceInfo := Sequence
  {
```

| | | |
|---|---|---|
| schedulingGapAssistance | schedulingGapAssistance | OPTIONAL, |

| | |
|---|---|
| gapGranularity | ENUMERATED {per UE, FR1, FR2, MCG, SCG, CC} |

OPTIONAL,

| | | |
|---|---|---|
| ccIndex | CCIndex | OPTIONAL |

}

In some implementations, the SN may determine the schedulingGapConfigure to the MN or to the UE via a SRB3 immediately as below:

```
  schedulingGapConfigure := Sequence
  {
```

| | | |
|---|---|---|
| schedulingGapConfig | SetupRelease { SchedulingGapConfigList } | OPTIONAL, |

| | |
|---|---|
| gapGranularity | ENUMERATED {per UE, FR1, FR2, MCG, SCG, CC} |

OPTIONAL,

| | | |
|---|---|---|
| ccIndex | CCIndex | OPTIONAL |

}

In some implementations, when the SN sends the schedulingGapConfigure to the MN, the MN may send the schedulingGapConfigure to the UE in the reconfiguration message.

In various examples/implementation/embodiments in the present disclosure, the gap granularity may be configured for all of the gaps, or alternatively, the gap granularity may also be configured for each gap.

### Embodiments on UE Indicating the Related Capability

Various embodiments describe how a UE indicates the related capability to the network. In some implementations, the UE indicates the supported scheduling gap types to the network (e.g. per UE gap, per FR gap, per CG gap, per CC gap) in a UE capability. This capability may be used for the MR-DC or CA case.

In some implementations, the network configures the UE to report the preferred scheduling Gap granularity (e.g. per UE gap, per FR gap, per CG gap, per CC gap).

In some implementations, the network may also indicate the dedicated granularity to the UE in other configuration. For a non-limiting example, the network may indicate per UE/per FR/per CG, which means that the network only support the UE to report these 3 kinds of granularity, i.e. without support per CC gap. For another non-limiting example, the network may indicate the supported scheduling gap type with a bitmap.

In some implementations, when the network only indicates the UE to report gap granularity (without indicates the dedicated granularity), it means that the network support all of them, and it's left the UE to determine the granularity.

The various examples/implementation/embodiments described in the present disclosure not only are applicable to the MR-DC case, they are also applicable to the CA case. Similarly, they are not restricted for the MUSIM UE, and may be applicable for the UEs that camp/connect to more than one networks at the same time.

The various examples/implementation/embodiments described in the present disclosure may also be extended to any other gaps, e.g., measurement gap.

The present disclosure describes various embodiment for the temporary capability restriction indication for the Dual-RX/Dual-TX UE. In some implementations, there are enhancements for MUSIM procedures to operate in RRC_CONNECTED state simultaneously in a network (NW) A and a NW B, for example, RAN2, RAN3, and/or RAN4. Specify mechanism may be used to indicate preference on temporary UE capability restriction and removal of restriction (e.g. capability update, release of cells, (de) activation of configured resources) with NW A when UE needs transmission or reception (e.g., start/stop connection to NW B) for MUSIM purpose. For radio access technology (RAT) concurrency, Network A is NR SA (with CA) or NR DC; and/or Network B may be either LTE or NR. For applicable UE architecture, it may be Dual-RX/Dual-TX UE.

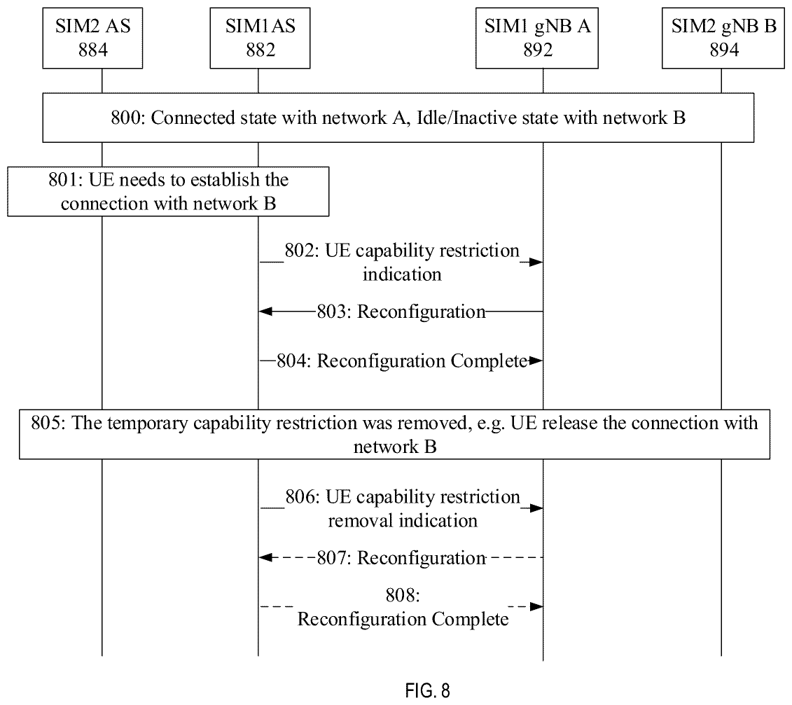

For a non-limiting example, FIG. 8 shows a general procedure for a UE capability restriction indication and removal a UE may include a SIM1 access stratum (AS) 882 and a SIM2 AS 884, which are configured to connect to a SIM1 e/gNB A (network A) 892 and a SIM2 e/gNB B (network B) 894, respectively. The procedure may include a portion or all of the following steps. In step 800, the UE may be in a connected state with the network A, and in an idle/inactive state with the network B. In step 801, the UE needs to establish the connection with the network B. In step 802, the UE (e.g., SIM1 AS) sends UE capability restriction indication to the network A. In step 803, the network A sends reconfiguration to the UE. In step 804, the UE sends reconfiguration complete to the network A. In step 805, the temporary capability restriction is removed, for example, when the UE release the connection with the network B. In step 806, the UE sends UE capability restriction removal indication to the network A. Optionally, in step 807, the network A sends reconfiguration to the UE. Optionally, in step 808, the UE sends reconfiguration complete t the network B.

In some implementations, when the UE works at a connected state with a network and the UE needs to establish the connection with network B, the UE may indicate the UE capability restriction to the network A and wait for the network A's response (e.g. Reconfiguration), then after the UE releases the connection from the network B, the UE may indicate the UE capability restriction removal to the network B.

In some implementations, the UE may report the temporary capability restriction, including but not limited to, allowed/forbidden band combination (BC) or feature set or the max MIMO layer, max CC numbers as the power saving/overheating, or Scell/SCG release, in the UAI. The temporary capability restriction may include capability update, release of cells, (de) activation of configured resources and so on. The UE may indicate such restriction with band combination information.

In some implementations, in the current UE capability structure, a band combination list may be reported. For each BC, there may be a FeaturesetCombination. For each FeaturesetCombination, there may be one or more featureset combinations.

For a non-limiting example, for a BC1, there are 3 featureset combination entries; and BC1→FeaturesetCombination ID x

$$( \begin{matrix}Band 1 & B a n d 2 & B a n d 3 & B C 1 \\ F e a t u r e S e {t}_{1.1} & F e a t u r e S e {t}_{2.1} & F e a t u r e S e {t}_{3.1} & 1 \\ F e a t u r e S e {t}_{1.2} & F e a t u r e S e {t}_{2.2} & F e a t u r e S e {t}_{3.2} & 2 \\ F e a t u r e S e {t}_{1.3} & F e a t u r e S e {t}_{2.3} & F e a t u r e S e {t}_{3.3} & 3\end{matrix} )$$

In some implementations, to report temporary capability restriction, the UE may indicate at least one of the below BC lists.

Allowed BC list: the BC with the corresponding feature set capability may be used without any restriction.

Affected BC list: there may be some restriction on these BCs.

Forbidden BC list: these BCs may be forbidden.

For the Affected BC list, the UE may further indicate the affected featureset combination entry Entries.

In some implementations, the featureset combination entry may include at least one of the following featureset combination entry lists.

Allowed featureset combination entry list: the featureset combination entry with the corresponding Feature set capability may be used without any restriction.

Affected featureset combination entry list: there may be some restriction on these featureset combination entries.

Forbidden featureset combination entry list: these featureset combination entries may be forbidden.

In some implementations, for the BC1, the UE may only support feature set combination entry 1, 3, then the UE may indicate forbidden feature set combination entry 2 into the forbidden feature set entry list for the BC 1 or indicate feature set combination entry 1, 3 to the network. The UE may also indicate some other critical limitation (e.g., max MIMO layer, max modulation order) to these affected BC list or to each BC that included in the affected BC list.

For a non-limiting example, in the above feature set combination entry 1, 3 that is allowed to be used but affected by the temporary UE capability restriction, the UE may further indicate the max MIMO layer=4, max CC number=2.

In some implementations, the temporary capability restriction may include allowed/affected/forbidden BC information, allowed/affected/forbbiden featureset combination entry list, dedicate capability parameters limitation (e.g., max MIMO layer, max modulation order). The dedicate capability parameters limitation may be set for all BC, or for each BC, or for each feature set combination entry of each BC.

In some implementations, similarly as described above, the UE may also indicate scell/SCG deactive/release implicitly.

In some implementations, the network may determine the scell/SCG deactive/release based on the above temporary capability restriction information.

The present disclosure describes methods, apparatus, and computer-readable medium for wireless communication. The present disclosure addressed the issues with scheduling gap coordination. The methods, devices, and computer-readable medium described in the present disclosure may facilitate the performance of wireless transmission between a user equipment and multiple network nodes, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
determining, by a user equipment (UE), a scheduling gap (SG) granularity in a network; and
transmitting, by the UE, a message comprising the determined SG granularity to the network.

2. The method according to claim 1, further comprising:
receiving, by the UE, reconfiguration information from the network; and
transmitting, by the UE, reconfiguration complete information to the network.

3. The method according to claim 1, wherein:
the message comprises a UE assistance information (UAI) message with SG request.

4. The method according to claim 1, wherein:
in response to the determined SG granularity being per UE gap, the message indicates per UE granularity information; or
in response to the determined SG granularity being per frequency range (FR) gap, the message indicates one of a first FR (FR1) or a second FR (FR2); or
in response to the determined SG granularity being per cell group (CG) gap, the message indicates one of a master cell group (MCG) or a secondary cell group (SCG); or
in response to the determined SG granularity being per component carrier (CC) gap, the message indicates at least one CC index.

5. The method according to claim 1, wherein:
the message comprises a SG list; and
the message comprises one of the following:
a SG granularity for the SG list, or
a SG granularity for each SG in the SG list.

6. The method according to claim 1, wherein:
the network changes the determined SG granularity from the UE to obtain a modified SG granularity; and
reconfiguration information from the network comprises the modified SG granularity.

7. The method according to claim 1, wherein:
in response to the determined SG granularity being reserved for a SCG, the UE transmits the message directly to a secondary node via a signal radio bearer (SRB).

8. A method for wireless communication, comprising:
receiving, by a network, assistance information from a user equipment (UE);
configuring, by the network based on the assistance information, a scheduling gap (SG) granularity;
transmitting, by the network, reconfiguration information to the UE, the reconfiguration information comprising the SG granularity; and
receiving, by the network, reconfiguration complete information from the UE.

9. The method according to claim 8, wherein:
the assistance information comprises at least one of the following: band information, an affected center frequency, an affected bandwidth, FR information, PDSCH configuration information, a MIMO layer, a modulation order, allowed band combination information, affected band combination information, featureset combination information, or featureset entry information.

10. The method according to claim 9, wherein:
the network comprises a master node and a secondary node;
the master node sends a first message to the secondary node, the first message comprising SG information with the determined SG granularity;
in response to determining that the SG information is acceptable, the secondary node sends a second message to the master node, the second message indicating an acceptance of the SG information with the determined SG granularity implicitly or explicitly; and
the master node sends the reconfiguration information to the UE.

11. The method according to claim 10, wherein:
the first message comprises CG configuration information; and
the second message comprises CG configuration.

12. The method according to claim 9, wherein:
in response to the determined SG granularity being per UE gap:
a master node determines SG information and sends a first message comprising the SG information with the SG granularity to a secondary node,
the secondary node sends a second message indicating an acceptance of the SG information to the master node implicitly or explicitly, and
the master node configures the SG information with the SG granularity to the UE; or
in response to the determined SG granularity being per FR gap and a SCG comprising a serving cell on a corresponding FR:
the master node sends a first message comprising SG information with the SG granularity to the secondary node,
the secondary node sends a second message indicating an acceptance of the SG information to the master node implicitly or explicitly, and
the master node configures the SG information with the SG granularity to the UE; or
in response to the determined SG granularity being per CG gap for an MCG gap:
the master node configures the SG information with the SG granularity to the UE; or
in response to the determined SG granularity being per CG gap for an SCG gap:
the master node sends a first message comprising assistance information, SG information with the SG granularity to the secondary node,
the secondary node determines the SG information and sends a second message indicating an acceptance of the SG information to the master node, and
the master node configures the SG information with the SG granularity to the UE; in response to the determined SG granularity being per CC gap and a SCG comprising a or serving cell on a corresponding CC;
the master node sends a first message comprising assistance information, SG information with the SG granularity, and one or more related CC index to the secondary node,
the secondary node determines the SG information and sends a second message indicating an acceptance of the SG information to the master node, and
the master node configures the SG information with the SG granularity to the UE.

13. The method according to claim 9, wherein:
in response to the determined SG granularity being per CG gap for an SCG gap:
a master node sends a first message comprising at least one of assistance information, or SG information with the SG granularity to a secondary node,
the secondary node determines the SG information, and
the secondary node transmits the SG information with the SG granularity to the UE directly via an SRB; or
in response to the determined SG granularity being per CC gap and a SCG comprising a serving cell on a corresponding CC:
the master node sends a first message comprising at least one of assistance information, SG information with the SG granularity, or one or more related CC index to the secondary node,
the secondary node determines the SG information, and
the secondary node transmits the SG information with the SG granularity to the UE directly via an SRB.

14. The method according to claim 9, wherein:
the UE transmits UE capability information to the network, the UE capability information indicating one or more SG granularity that are supported by the UE, the one or more SG granularity comprising one or more of the following: per UE SG, per FR SG, per CG SG, and per CC SG.

15. The method according to claim 9, wherein:
the network indicates the UE to report SG granularity with at least one dedicated SG type, so that the UE is limited to determine the SG granularity with a SG type in the at least one dedicated SG type; or
the network indicates the UE to report SG granularity without any dedicated SG type, so that the UE determines the SG granularity with any SG type.

16. (canceled)

17. (canceled)

18. An apparatus comprising:
a memory storing instructions; and
at least one processor in communication with the memory, wherein, when the at least one processor executes the instructions, the at least one processor is configured to cause the apparatus to perform:
determining a scheduling gap (SG) granularity in a network; and
transmitting a message comprising the determined SG granularity to the network.

19. The apparatus according to claim 18, wherein, when the at least one processor executes the instructions, the at least one processor is configured to further cause the apparatus to perform:
receiving reconfiguration information from the network; and
transmitting reconfiguration complete information to the network.

20. The apparatus according to claim 18, wherein:
the message comprises a UE assistance information (UAI) message with SG request.

21. An apparatus comprising:
a memory storing instructions; and
at least one processor in communication with the memory, wherein, when the at least one processor executes the instructions, the at least one processor is configured to cause the apparatus to perform:
receiving assistance information from a user equipment (UE);
configuring, based on the assistance information, a scheduling gap (SG) granularity;
transmitting reconfiguration information to the UE, the reconfiguration information comprising the SG granularity; and
receiving reconfiguration complete information from the UE.

22. The apparatus according to claim 21, wherein:
the assistance information comprises at least one of the following: band information, an affected center frequency, an affected bandwidth, FR information, PDSCH configuration information, a MIMO layer, a modulation order, allowed band combination information, affected band combination information, featureset combination information, or featureset entry information.
